(19) United States
(12) Patent Application Publication
(10) Pub. No.: US 2018/0127244 A1
(43) Pub. Date: May 10, 2018

(54) ELEVATOR COUNTERWEIGHT ASSEMBLY

(71) Applicant: OTIS ELEVATOR COMPANY, Farmington, CT (US)

(72) Inventor: Aurelien Fauconnet, Isdes (FR)

(21) Appl. No.: 15/799,769

(22) Filed: Oct. 31, 2017

(30) Foreign Application Priority Data
Nov. 4, 2016 (EP) 16290213.4

(51) Int. Cl. B66B 17/12; B66B 19/00

(52) U.S. Cl. CPC B66B 17/12; B66B 19/00

(57) ABSTRACT

An elevator counterweight assembly includes a frame and a weight. The frame is constructed and arranged to move between a collapsed state and a deployed state. The weight is supported by the frame when in the deployed state

### BACKGROUND

Exemplary embodiments pertain to the art of elevator systems, and more particularly, to a counterweight assembly of the elevator system.

Elevator systems may include an enclosed car for transporting passengers and/or cargo vertically in a hoistway. A rope (i.e., including a cable or belt embodiment) of the elevator system may generally extend between the car and a counterweight assembly. A drive or motor of the elevator system may be generally coupled to the rope for moving the car up and down as the counterweight respectively moves down and up. The counterweight may weigh about the same as a half-loaded car and functions to assist the drive in moving the car thereby reducing energy consumption. Known counterweight assemblies may have numerous parts, and may be difficult and cumbersome to transport, install and/or perform maintenance on in the field.

### BRIEF DESCRIPTION

An elevator counterweight assembly according to one, non-limiting, embodiment of the present disclosure includes a frame constructed and arranged to move between a collapsed state and a deployed state; and a first weight supported by the frame when in the deployed state.

Additionally to the foregoing embodiment, the frame includes a plurality of members and a plurality of joints, and wherein each member is engaged to the adjacent member by a joint of the plurality of joints.

In the alternative or additionally thereto, in the foregoing embodiment, the elevator counterweight assembly includes a sheave engaged to the frame.

In the alternative or additionally thereto, in the foregoing embodiment, each joint of the plurality of joints includes at least one pin extending through adjacent members of the plurality of members and along a pivot axis.

In the alternative or additionally thereto, in the foregoing embodiment, the at least one pin is a threaded bolt.

In the alternative or additionally thereto, in the foregoing embodiment, each joint of the plurality of joints include a locking feature constructed and arranged to lock the frame in the deployed state.

In the alternative or additionally thereto, in the foregoing embodiment, the locking feature is a snap fit arrangement carried between adjacent members of the plurality of members.

In the alternative or additionally thereto, in the foregoing embodiment, the locking feature includes a detachable fastener spaced from the centerline.

In the alternative or additionally thereto, in the foregoing embodiment, the detachable fastener is a threaded fastener constructed and arranged to extend through adjacent members of the plurality of members.

In the alternative or additionally thereto, in the foregoing embodiment, the locking feature is disposed between the pivot axis and an end of at least one of the adjacent members.

In the alternative or additionally thereto, in the foregoing embodiment, the elevator counterweight assembly includes a second weight supported by the frame when in the deployed state.

In the alternative or additionally thereto, in the foregoing embodiment, the plurality of members include upper and lower beams disposed substantially horizontally, and left and right uprights disposed substantially vertically when in the deployed state.

In the alternative or additionally thereto, in the foregoing embodiment, the upper beam is substantially collinear with the right upright, and the lower beam is substantially collinear with the left upright when in the collapsed state.

In the alternative or additionally thereto, in the foregoing embodiment, the plurality of joints include an upper right joint carried between the upper beam and the right upright, a lower right joint carried between the right upright and the lower beam, a lower left joint carried between the lower beam and the left upright, and an upper left joint carried between the left upright and the upper beam.

In the alternative or additionally thereto, in the foregoing embodiment, the lower right and lower left joints each include a pin extending through respective adjacent members and along a pivot axis.

In the alternative or additionally thereto, in the foregoing embodiment, the lower right and lower left joints each include a locking feature carried between respective pivot axis and respective distal ends of the right and left uprights.

In the alternative or additionally thereto, in the foregoing embodiment, the locking feature of the lower right joint is spaced below the pivot axis of the lower right joint when in the deployed state, and the locking feature of the lower left joint is spaced above the pivot axis of the lower left joint when in the deployed state.

A method of erecting an elevator counterweight assembly according to another, non-limiting, embodiment includes unfolding a frame from a collapsed state to a deployed state; and attaching at least one weight to the frame.

Additionally to the foregoing embodiment, the method includes engaging a locking feature of each one of a plurality of joints of the frame when in the deployed state.

The foregoing features and elements may be combined in various combinations without exclusivity, unless expressly indicated otherwise. These features and elements as well as the operation thereof will become more apparent in light of the following description and the accompanying drawings. However, it should be understood that the following description and drawings are intended to be exemplary in nature and non-limiting.

### BRIEF DESCRIPTION OF THE DRAWINGS

The following descriptions should not be considered limiting in any way. With reference to the accompanying drawings, like elements are numbered alike:

FIG. 1 is a perspective view of an elevator system as one exemplary embodiment of the present disclosure with portions removed to show internal detail;

FIG. 2 is a front view of an elevator counterweight assembly of the elevator system with a frame in a deployed state;

FIG. 3 is a front view of the frame in a mid-state;

FIG. 4 is a front view of the frame in a collapsed state;

FIG. 5 is a partial exploded view of the frame; and

FIG. 6 is a perspective view of a joint of the frame.

### DETAILED DESCRIPTION

A detailed description of one or more embodiments of the disclosed apparatus and method are presented herein by way of exemplification and not limitation with reference to the Figures.

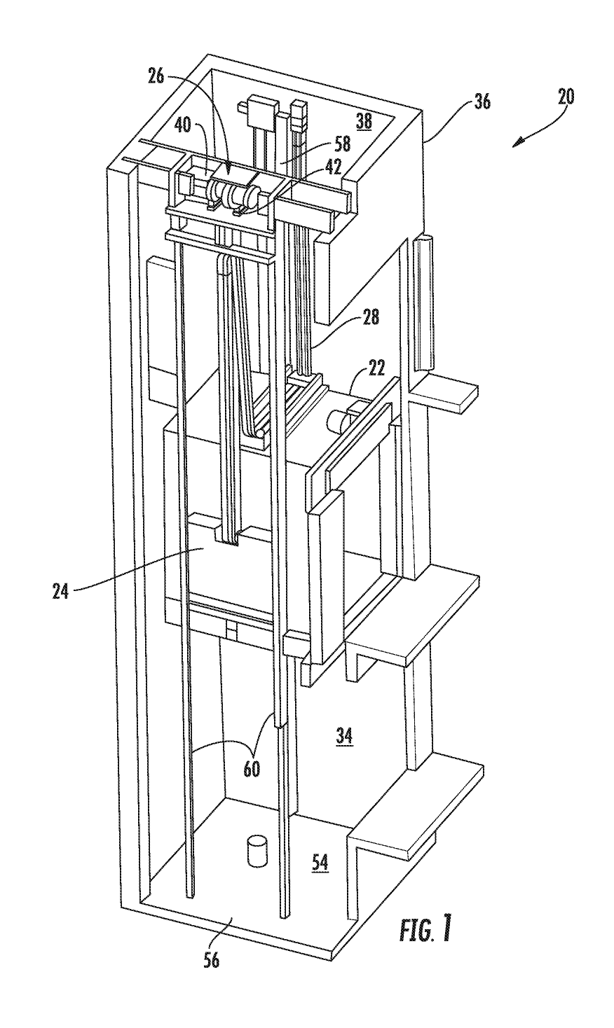

Referring to FIG. 1, an elevator system 20 of the present disclosure is illustrated, and may include a car 22, a counterweight assembly 24, a drive device 26, and a rope 28. The car 22 may carry passengers or other objects and is constructed to move substantially vertically in a hoistway 34 of the elevator system 20. Boundaries of the hoistway 34 may be defined by a stationary structure or building 36 that may utilize and house the elevator system 20. The drive device 26 may, or may not, be housed in a machine room 38 of the building 36 located generally above the hoistway 34, and may include an electric motor 40 that rotates a sheave 42. The rope 28 is wrapped about the sheave 42, and extends between the car 22 and the counterweight assembly 24. When the drive device 26 receives a command signal to raise the car 22, the sheave 42 rotates in a first direction that lowers the counterweight assembly 24 as the car 22 rises, and vice-versa. The counterweight assembly 24 generally weighs about the same as the car 22 when at about half capacity, and thus reduces the work output requirements of the drive device 26. It is contemplated and understood that the term ‘rope’ includes similar terms such as cable, belt, and others.

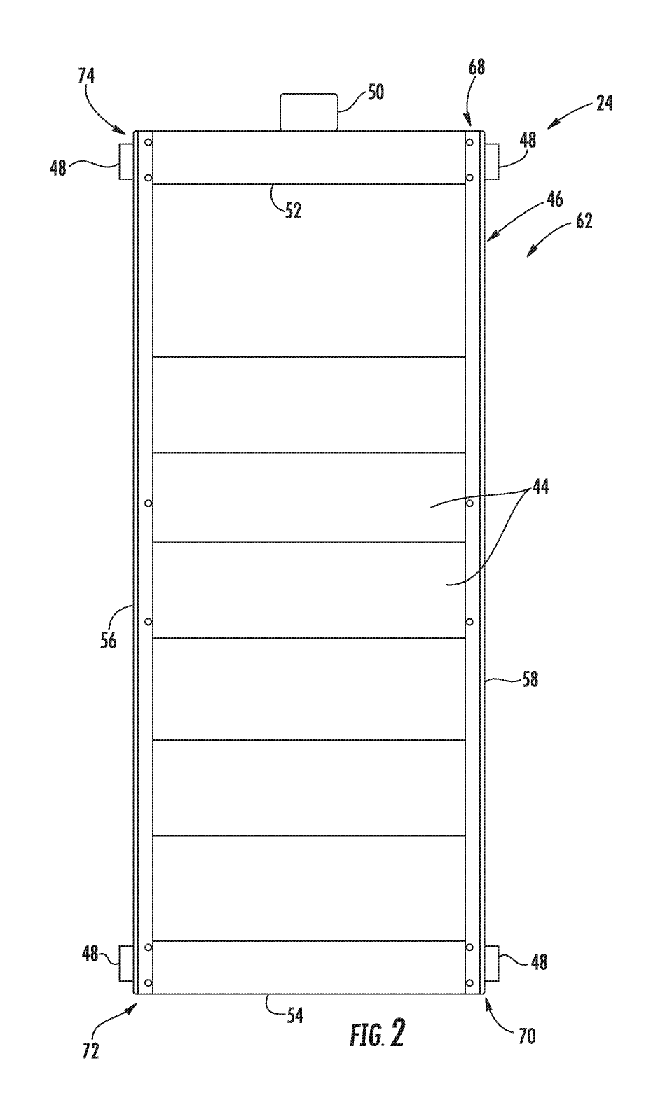

Referring to FIGS. 1 and 2, the counterweight assembly 24 is illustrated in a deployed state, and may include a plurality of counterweights 44, a frame 46, a plurality of guiding devices 48, and a sheave 50. The frame 46 may include a plurality of members interconnected by a plurality of joints. The plurality of members may include, laterally spaced, upper and lower beams 52, 54, and laterally spaced, left and right uprights 56, 58. The beams 52, 54 may each span substantially horizontally when deployed and between the uprights 56, 58, and the uprights 56, 58 may each span substantially vertically when deployed and between the beams 52, 54. It is contemplated and understood that the counterweights 44, also known as counterweight fillers, may be made of concrete and/or steel.

The counterweights 44 are supported by the frame 46 and may span between and are coupled to the uprights 56, 58. In one embodiment, the counterweights 44 may generally rest upon the lower beam 54. The plurality of guiding devices 48 may be attached to each upright 56, 58 (i.e. two illustrated at each upright) and are adapted to operatively couple with vertical rails 60 (see FIG. 1) disposed along the hoistway 34. The sheave 50 may be engaged to the upper beam 52 and is operatively coupled to the rope 28. It is further contemplated and understood that the sheave, in some elevator configurations, may be replaced with a rope termination point as is known in the art.

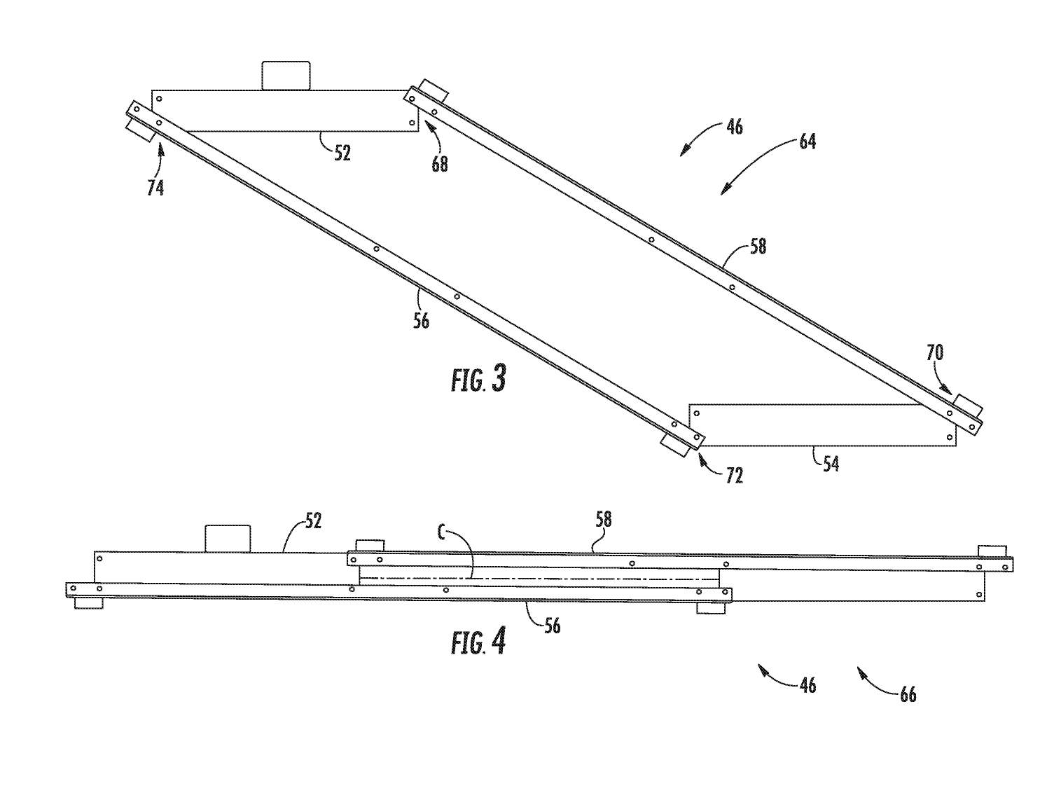

Referring to FIGS. 2 through 4, with the counterweights 44 removed, the frame 46 is constructed and arranged to fold and unfold, generally as one articulating piece, between the deployed state 62 (see FIG. 2), a mid-state 64 (see FIG. 3), and a collapsed state 66 (see FIG. 4). When the frame 46 is in the deployed state 62, the frame may be orthogonal in shape. When in the collapsed state 66, the frame may be substantially linear with all of the members generally lying along a centerline C. That is and in one example, the upper beam 52 may be collinear with the right upright 58, and the lower beam 54 may be collinear with the left upright 56. Furthermore and when in the collapsed state 66, the beam 52 and upright 58, together, may be co-axial with the beam 54 and the left upright 56.

A plurality of joints or hinges of the frame 46 are carried between adjacent members and facilitate folding of the frame 46. More specifically and in view of the frame 46 when in the deployed state 62 (see FIG. 2), the frame 46 may include an upper right joint 68, a lower right joint 70, a lower left joint 72, and an upper left joint 74. The upper right joint 68 may operatively connect a right end portion of the upper beam 52 to an upper end portion of the right upright 58. The lower right joint 70 may operatively connect a lower end portion of the right upright 58 to a right end portion of the lower beam 54. The lower left joint 72 may operatively connect a left end portion of the lower beam 54 to a lower end portion of the left upright 56. The upper left joint 74 may operatively connect an upper end portion of the left upright 56 to a left end portion of the upper beam 52. It is understood that the terms ‘left’ and ‘right’ are in reference to the illustrated perspective of the figures. It is further understood, that when using the terms ‘left’ and ‘right’, the associated components may generally be reversed in design (i.e., vice-versa), and/or simply viewing the elevator counterweight assembly 24 from an opposite side.

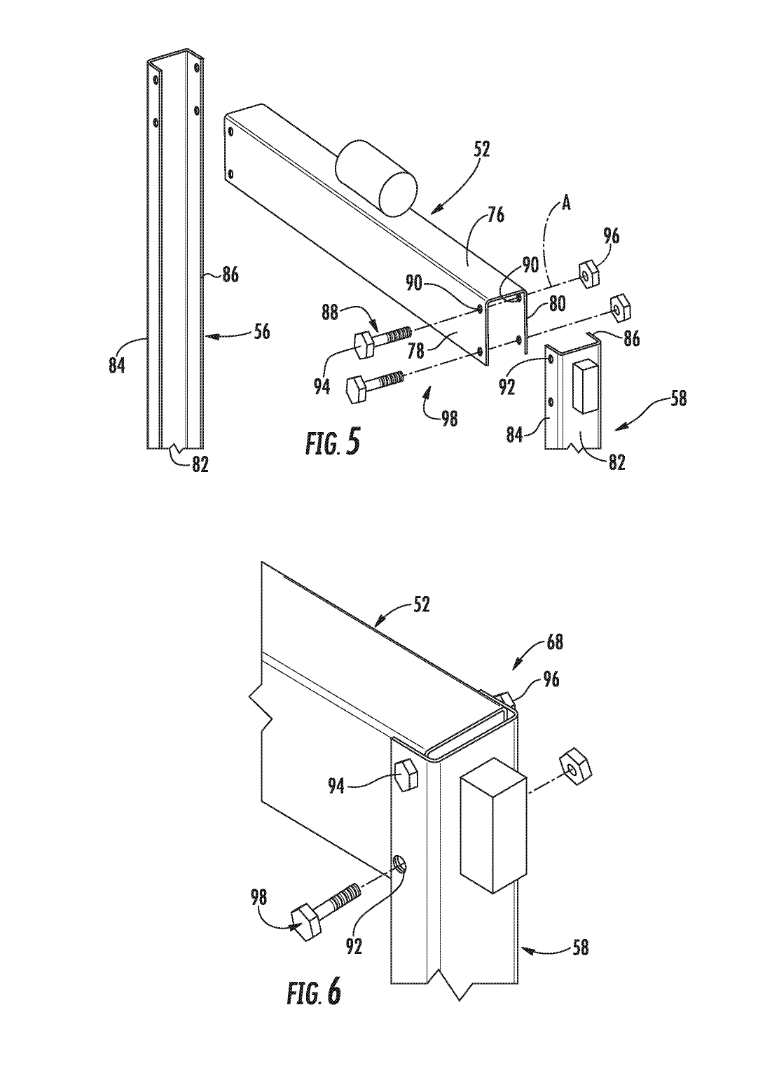

Referring to FIGS. 5 and 6, in one embodiment, the upper and lower beams 52, 54 may be U-channels (i.e., are U-shaped in cross section) having a web 76 laterally spanning between two legs 78, 80. Similarly, the uprights 56, 58 may be U-channels each including a web 82 spanning between two legs 84, 86. The legs 78, 80 of each of the beams 52, 54 may generally project downward from the webs 76, when the frame is in the deployed state 62. The legs 84, 86 of the left upright 56 may project substantially in a horizontal direction and toward the opposing legs 84, 86 of the right upright 58. In one embodiment, the width of the web 76 of the beams 52, 54 maybe slightly less than the width of the web 82 of the uprights 56, 58, such that the web 76 of the beams 52, 54 may be generally disposed between the legs 84, 86 of the respective uprights 56, 58. When the counterweights 44 are secured to the frame 46, end portions of the counterweights may be located between the legs 84, 86 of each upright 56, 58 to assist in securing and/or stabilizing the counterweights to the frame. It is further contemplated and understood that at least a portion of the counterweights may bear directly upon the web 76 of the lower beam 54.

It is contemplated and understood that the legs 78, 80 of the upper beam 52, and/or the lower beam 54 may project upward instead of downward. Such configurations may be dependent upon how auxiliary components may be attached to the frame 64, such as, for example, the sheave 50. It is further contemplated and understood that the beams 52, 54 and uprights 56, 58 may not be U-channels and instead may include any variety of cross-sectional shapes that may or may not be hollow in design. Such shapes may be dependent upon how the counterweight weight and/or how the counterweight attaches to the uprights 56, 58 and/or the beams 52, 54. The choice of cross-sectional shape may be further dependent upon the design of the joints 68, 70, 72, 74.

For simplicity of explanation and referring further to FIGS. 5 and 6, the upper right joint 68 will now be described; however, it is understood that the joints 70, 72, 74 may be generally similar to joint 68. In one embodiment, joint 68 may include a pin 88 that extends through two axially aligned holes or openings 90 in the respective legs 78, 80 of the upper beam 52, and through two holes or openings 92 in the respective legs 84, 86 of the right upright 58. The pin 88 extends along a pivot axis A that may be substantially normal to the beam 52 and upright 58. The pin 88 may be, or may be part of, a threaded fastener or bolt with an enlarged head 94 at one end, and a threaded nut 96 at an opposite end. The pin 88 remains operatively connected to the upper beam 52 and the right upright 58 regardless of whether the frame is in the collapsed state 66, the mid state 64 or the deployed state 62. It is further contemplated and understood that the joint 68 may take the form of other hinge-like devices capable of enabling a pivoting motion between the beams and uprights. In another example, the pin 88 may be a two-part pin with individual parts extending through respective holes 90.

Each joint 68, 70, 72, 74 may further include a locking feature 98 that may be vertically spaced from the pivot axis A when the frame 46 is in the deployed state 62. More specifically and in one embodiment, for joint 68 the locking feature 98 may be vertically spaced below the pin 88, for joint 70 the locking feature 98 may be vertically spaced below the pin 88, for joint 72 the locking feature 98 may be vertically spaced above the pin 88, and for joint 74 the locking feature 98 may be vertically spaced above the pin 88. The locking feature 98 for each joint 68, 70, 72, 74 may be a detachable fastener (e.g., threaded fastener) and may be similar to that of the pin 88 previously described except that the detachable fastener does not extend along a pivot axis. In another embodiment and referring to joint 68 in FIGS. 5 and 6, the locking feature 98 may be carried between the legs 84, 86 of the right upright 58 and the legs 78, 80 of the upper beam 52. That is, the one or more of the legs 78, 80, 84, 86 may be resiliently flexible to facilitate a snap fit directly between, for example, legs 78, 84. Although not shown, one leg may carry a divit or recess and the other leg may carry a protuberance that snap fits into the recess as the frame moves from the mid-state 64 and into the deployed state 62. Alternatively, the locking feature 98 may be any one of screws, rivets, cutter pins, and other fasteners. When the frame 46 is not in the deployed state 62, the locking feature is not engaged. It is further contemplated and understood that under some applications only one joint may have a locking feature, or in another embodiment, none of the joints may include the locking feature, and instead, the presence of the weights may be sufficient to establish desired frame rigidity.

In one embodiment, and to enable a more compact shape when the frame 46 is in the collapsed state 66 (see FIG. 4), the joints 68, 70 may be orientated differently than the joints 72, 74. That is and when viewing the frame 46 in the deployed state 62, the pin 88 and associated pivot axis A of the joints 68, 70 may be spaced above the respective locking features 98. In contrast, the pin 88 and associated pivot axis A of the joints 72, 74 may be spaced below the respective locking features 98. It is contemplated and understood that any variety of joints with or without locking features may be adapted. Furthermore, any configuration of multiple joints with both a pivot axis and a locking feature may be adapted and may be dependent upon the overall shape of the frame 46.

Advantages and benefits of the present disclosure include a simplification and a reduction in time with regard to the installation of an elevator counterweight assembly. Other advantages include a partially, factory, assembled counterweight assembly that is relatively compact and easy to transport with minimal loose parts.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

1. An elevator counterweight assembly comprising:
a frame constructed and arranged to move between a collapsed state and a deployed state; and
a first weight supported by the frame when in the deployed state.

2. The elevator counterweight assembly set forth in claim 1, wherein the frame includes a plurality of members and a plurality of joints, and wherein each member is engaged to the adjacent member by a joint of the plurality of joints.

3. The elevator counterweight assembly set forth in claim 2, further comprising:
a sheave engaged to the frame.

4. The elevator counterweight assembly set forth in claim 3, wherein each joint of the plurality of joints includes at least one pin extending through adjacent members of the plurality of members and along a pivot axis.

5. The elevator counterweight assembly set forth in claim 4, wherein the at least one pin is a threaded bolt.

6. The elevator counterweight assembly set forth in claim 5, wherein each joint of the plurality of joints include a locking feature constructed and arranged to lock the frame in the deployed state.

7. The elevator counterweight assembly set forth in claim 6, wherein the locking feature is a snap fit arrangement carried between adjacent members of the plurality of members.

8. The elevator counterweight assembly set forth in claim 6, wherein the locking feature includes a detachable fastener spaced from the centerline.

9. The elevator counterweight assembly set forth in claim 8, wherein the detachable fastener is a threaded fastener constructed and arranged to extend through adjacent members of the plurality of members.

10. The elevator counterweight assembly set forth in claim 9, wherein the locking feature is disposed between the pivot axis and an end of at least one of the adjacent members.

11. The elevator counterweight assembly set forth in claim 10, further comprising:
a second weight supported by the frame when in the deployed state.

12. The elevator counterweight assembly set forth in claim 11, wherein the plurality of members include upper and lower beams disposed substantially horizontally, and left and right uprights disposed substantially vertically when in the deployed state.

13. The elevator counterweight assembly set forth in claim 12, wherein the upper beam is substantially collinear with the right upright, and the lower beam is substantially collinear with the left upright when in the collapsed state.

14. The elevator counterweight assembly set forth in claim 13, wherein the plurality of joints include an upper right joint carried between the upper beam and the right upright, a lower right joint carried between the right upright and the lower beam, a lower left joint carried between the lower beam and the left upright, and an upper left joint carried between the left upright and the upper beam.

15. The elevator counterweight assembly set forth in claim 14, wherein the lower right and lower left joints each include a pin extending through respective adjacent members and along a pivot axis.

16. The elevator counterweight assembly set forth in claim 15, wherein the lower right and lower left joints each include a locking feature carried between respective pivot axis and respective distal ends of the right and left uprights.

17. The elevator counterweight assembly set forth in claim 16, wherein the locking feature of the lower right joint is spaced below the pivot axis of the lower right joint when in the deployed state, and the locking feature of the lower left joint is spaced above the pivot axis of the lower left joint when in the deployed state.

18. A method of erecting an elevator counterweight assembly comprising:
unfolding a frame from a collapsed state to a deployed state; and
attaching at least one weight to the frame.

19. The method set forth in claim 18 further comprising:
engaging a locking feature of each one of a plurality of joints of the frame when in the deployed state.
